(19) United States
(12) Patent Application Publication
(10) Pub. No.: US 2001/0011690 A1
(43) Pub. Date: Aug. 9, 2001

(54) Device for steering and tensioning a web

(76) Inventors: Louis Luyckx, St. Katelijne Waver (BE); Jan De Bock, Melsele (BE)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/776,978

(22) Filed: Feb. 5, 2001

(30) Foreign Application Priority Data
Feb. 5, 2000 (GB) 0002617.9

(51) Int. Cl. B65H 23/038; B65H 23/04; F16H 7/12; F16H 7/22

(52) U.S. Cl. 242/417.3; 226/21; 474/103; 474/135

(57) ABSTRACT

A device for actively steering and tensioning a web as it moves along a predetermined path is described. The web is partially wrapped around a rotatable guide roller. A first end of the guide roller is carried on a tiltable support member. The opposite end is attached to a pivotal bearing. A non-contact sensor is positioned to detect lateral misalignment of the web. A control device responsive to the sensor controls the tilting of the support member thereby to correct for lateral misalignment of the web. Pressure devices exert a predetermined pressure on each end of the guide roller independently of the position of the tiltable support member, to push the guide roller towards the web to generate the desired tension.

### FIELD OF THE INVENTION

This invention relates to a device for both steering and tensioning of a belt or a web. In particular endless belts are useful as intermediate members or image-forming members in graphic tools such as copiers, printers and the like.

### BACKGROUND OF THE INVENTION

In a typical printing or copying process, a latent image is formed on an image-forming member by image-wise exposure. The image-forming member can be an endless belt. Typical graphical processes include amongst others magnetography, ionography and electrography, particularly electrophotography. In the latter process for instance, the latent image is formed on a charged photosensitive member by image-wise exposure to light. The latent image is subsequently made visible on the image-forming member at a development zone. After the development of the latent image, the developed image is transferred to a recording medium, directly or via one or more intermediate members, where it may be permanently fixed. These intermediate members can be endless belts. This describes more or less the black and white or single color situation. In a multi-color configuration either a plurality of image-forming members is used or a plurality of development stations are introduced along the image-forming member. To obtain proper registration of the images on the recording medium or on the intermediate members accurate control over the movement of the different image-carrying members is a prerequisite. For instance lateral misalignment of an intermediate member at a transfer zone can cause incomplete transfer or bad registration across the member. Therefore steering of endless belts or webs supported by guide rollers is an awkward problem as it might seriously affect image quality.

In general, several implementations of active or passive steering of belts or webs are used in printing and copying devices. Passive steering implementations rely on a balance of forces to restrict the web to a predetermined path. These devices have the disadvantage that the exact position of the web cannot precisely be controlled. Furthermore passive devices may include edge guides which force the web to stay within a predetermined range. This can however affect the lifetime of the web as these edge guides might damage the edges of the web. Active steering devices continuously sense the position of the web and mechanically interact with the steering rollers to steer a web to a predetermined position. When a web is entrained over a roller, it is possible to adjust the angle at which the web enters and leaves the roller, to cause the web to laterally move along the axis of the roller. Although this seems to be a rather straightforward principle, in practice several constraints are imposed which render the implementation into a challenging problem. For instance just tilting a roller might locally introduce a change in the path length of the web which can cause creep or stretching of the web and therefore can result in all kinds of unacceptable image defects such as image elongation, registration errors, image wrinkles etc. In state-of-the-art solutions this tilting movement is performed by tilting the steering roller around a pivot point which is located in the middle of the roller. This means that both ends of the roller have to be able to perform such a tilting movement. Most state-of-the-art solutions, as e.g. in U.S. Pat. No. 5,717,984 (Wong/Xerox Corporation), introduce a kind of yoke arrangement to implement this ability. Such solutions may be expensive to build, space consuming, mechanically difficult to implement and complex to control. Moreover this solution does not allow one to keep the tension constant during steering.

U.S. Pat. No. 4,429,985 (Yokota/Ricoh Company Ltd) discloses a device in which a deviation signal is sensed upon movement of the endless belt. This deviation signal is used to pivot a roller, about which the belt is entrained, about an axis perpendicular to its rotary axis so as to apply differential tension to the belt to cause it to move along the pivoted roller. The pivot point is located in the middle of the roller which makes this solution less attractive. However the major disadvantage of this proposed solution is that the tension varies locally which as explained above might introduce all kinds of image defects mainly caused by creep or stretching.

We are aware of U.S. Pat. No. 4,966,653 (Oy Tampella) which describes an apparatus for controlling a moving band in a paper machine or the like. The position of one end of a roll over which the band passes can be adjusted by a bellows device.

We are also aware of a number of proposals for the non-active steering of belts and webs. Thus, British patent GB 1275134 (Rank Xerox) which describes a flexible material tracking system; U.S. Pat. No. 5,895,979 (Fuji Xerox) describes an endless belt type delivery device; and U.S. Pat. No. 5,397,043 describes a web tracking device with ramp support. Furthermore, U.S. Pat. No. 4,527,686 (Ricoh) describes a system for correcting deflection of a belt from its normal path of movement. Optical sensors are provided for sensing the deflection of the belt.

### OBJECTS OF THE INVENTION

It is an object of the present invention to provide an improved device for steering and tensioning a web, and in particular to provide a device allowing both tensioning and steering ability of the web without introducing image defects.

It is a further object of the invention to provide steering and tensioning of the web without generating global or local short-term length variations of the web.

A preferred objective is to realize this using a minimum of moving parts, simple control, limited space consumption and cost effectiveness.

### SUMMARY OF THE INVENTION

According to the invention, there is provided a device for actively steering and tensioning a web as it moves along a predetermined path, comprising: a rotatable guide roller for contacting the inner side of the web while the web is partially wrapped around the guide roller, a first end of the guide roller being carried on a tiltable support member while a second opposite end of the guide roller is attached to a pivotal bearing, thereby enabling tilting of the guide roller over a predetermined angle; a non-contact sensor positioned to detect lateral misalignment of the web; a control device responsive to the non-contact sensor for controlling the tilting of the support member thereby to correct for lateral misalignment of the web by corrective frictional steering thereof; and pressure devices for exerting a predetermined pressure on each end of the guide roller independently of the position of the tiltable support member, thereby to push the guide roller towards the web for tensioning thereof.

The invention also provides a method for actively steering and tensioning a web as it moves along a predetermined path, comprising:

contacting the inner side of the web with a rotatable guide roller while the web is partially wrapped around the guide roller, a first end of the guide roller being carried on a tiltable support member while a second opposite end of the guide roller is attached to a pivotal bearing, thereby enabling tilting of the guide roller over a predetermined angle;

detecting lateral misalignment of the web by means of a non-contact sensor;

using a control device responsive to the sensor to control the tilting of the support member thereby to correct for lateral misalignment of the web by corrective frictional steering thereof; and

using pressure devices for exerting a predetermined pressure on each end of the guide roller independently of the position of the tiltable support member, thereby, in use, to push the guide roller towards the web for tensioning thereof.

The web to be used with the device according to the invention may be selected from endless seamed or seamless belts and open ended webs. The invention is particularly of advantage where the belt is relatively stiff, so that, if the prior art devices were to be used, consistent contact between the belt and the steering roller could not be assured.

The guide roller preferably extends at least over the whole width of the web. In the following general description, references to a “belt” are to be understood to apply equally to other forms of web, except where the context implies otherwise.

The belt may be an intermediate transfer belt which comprises an electrically conductive backing member covered for example with a silicone elastomer, polytetrafluoroethylene, fluorosilicones, polyfluoralkylene and other fluorinated polymers. On top, a semi-insulating or insulating coating layer of, for example, a fluorosilicone, may be formed. Alternatively, a fabric backing may be used covered with a conductive (conformable) silicone layer, optionally covered with a top coating. In case a fabric backing is used, a pre-stressed fabric backing or a reinforced fabric backing is preferably used to increase the belt stiffness.

The belt is partially wrapped around the guide roller of the steering and tensioning device. Typically the wrapping angle is about 90 degrees.

The guide roller preferably extends along and is rotatable about an axis positioned substantially transversely of the predetermined belt path, that is to the propagation direction of the belt.

The guide roller is preferably cylindrical and its width is at least equal to the width of the belt but preferably it extends beyond the belt. The guide roller is preferably a freely rotatable roller but may alteratively be a driven roller. The guide roller may be formed of metal, such as from aluminum or steel.

The tilt axis of the tiltable support member preferably lies within the wrapping angle of the web around the guide roller. This tilting axis is preferably substantially parallel to the axis of the guide roller and most preferably lies on, or close to, the bisector of the wrapping angle. This arrangement means that the tilting of the support member results in substantially no variation in the speed of the web as it passes over the guide roller.

The predetermined pressure force exerted on at each end of the roller is ideally the same and is preferably in the range from 100 N to 2000 N. Particularly, in case of a metal based belt a typical force of about 520 N is used, while in case of a prestressed fabric based belt a typical force of about 725 N is used. This implementation assures that there are no short-term global length variations. This implementation can also allow for some stretching of the belt over its lifetime if the axle of the roller is located within such a space which allows the guide roller to move towards or away from the belt, to accommodate such stretching. Therefore long-term belt length variations in the order of a few centimeters can be allowed for while maintaining the desired tension. Where, in an example, the maximum belt length variation which still allows a correction to be made is about 7 centimeters, rather stiff belts are preferred.

The pressure devices may comprise a pair of compressed air devices, or a pair of compressible resilient elements such as springs. Preferably, the pressure devices are controllable to enable the tension in the web to be maintained at a constant predetermined level, even as the tiltable support member is tilted to steer the web, without generating localized distortions in the web which can result in image defects, independently of the elasticity of the web. For this reason, compressed air devices are preferred over resilient elements such as springs as it is difficult to obtain two identical resilient elements which makes it more cumbersome to exert and maintain identical pressure forces on both ends of the steering roller.

Preferably, one of the pressure devices is carried on the tiltable support member. By this arrangement it is possible to ensure that the predetermined pressure acts in a direction away from the tilt axis of the support member, most preferably in the direction of the bisector of the wrapping angle. The pressure devices preferably act in parallel directions.

The non-contact sensor can be provided close to the guide roller. In particular, an optical sensor can be used comprising a light source and a detector, with the belt passing in-between.

The control device is responsive to the non-contact sensor for correcting lateral misalignment of the belt by corrective frictional steering of the belt. Where the non-contact sensor is an optical sensor comprising a light source and a detector, an output voltage indicative of the alignment of the belt is measured at the detector. The arrangement may be such that if the desired position of the edge of the belt is centered at the detector, such that half of the light of the light source is absorbed or reflected by the belt, if the belt starts to drift laterally, the direction of this drift can be indicated by the detected output voltage. If this detected output voltage is greater than the output voltage when the belt edge is centered (Vc), this indicates that a larger part of the detector is being exposed and that therefore the belt has drifted in a first direction. If on the other hand the detected output voltage is smaller than Vc, this indicates that the belt has drifted in a second direction opposite to the first direction. Dependent on the sensor output reading, a feedback mechanism may be engaged to control the support member, enabling the first end of the guide roller to be tilted over a predetermined angle without changing the tensioning of the belt, while the second end of the guide roller is more or less unaffected by this steering motion. The pressure device at this first end of the roller is preferably mounted on the support member. This arrangement allows the steering motion to be executed without influencing the tensioning. The tilting angle can range from 100 to +100 or more preferably from −50 to +50. As stated above, the second end of the guide roller is more or less unaffected by the steering motion. This is made possible by mounting the second end by means of the pivotal bearing. The control device preferably also acts to ensure that the pressure exerted on each end of the guide roller is kept constant, even during tilting of the support member.

Advantageously, at least a surface layer of the guide roller is composed of a material having a predetermined coefficient of friction. As the steering is based on friction, this coefficient of friction may not be too low. On the other hand, the coefficient of friction may not be too high as this can introduced uncontrolled slip. In the case where the guide roller is an aluminum or steel roller, a typical surface layer is an oxide layer obtained by hard anodization. This layer has an increased hardness and a higher resistance to wear. The thickness of such a hard coat anodize is typically between 10 and 200 μm. The coefficient of friction of this hard coat anodize is substantially higher than the aluminum or steel base material. The coefficient of friction of the surface material can be further adjusted by impregnating this layer with a polymer, e.g. Teflon.

In a preferred embodiment, the belt passes over a number of guide rollers. Preferably the guide roller incorporating the steering and tensioning function has a coefficient of friction which is at least as high or higher then the coefficient of friction of the other guide rollers. Particularly, the steering roller can be provided with a hard coat anodize as a surface layer while the other rollers can be provided with a hard coat anodize impregnated with Teflon as a surface layer. Preferably, the number of guide rollers is kept to a minimum. By using the same guide roller to provide tensioning and steering of the belt, as in the present invention, rather than using separate guide rollers to provide these functions, the number of guide rollers can be reduced by at least one. By reducing the number of guide rollers, less space is required in the print engine and the wrapping angle of the belt around the guide rollers can be maximized. Greater wrapping angles provide greater adhesion of the belt to the guide rollers leading to more reliable drive.

In a preferred embodiment, the belt is supported by 5 guide rollers, which means that the wrapping angle of the belt around the steering and tensioning guide roller can typically be between 45° and 135°.

The need for fewer guide rollers also means that a smaller belt can be used which, in the case that the belt is a heated belt, is particularly beneficial for power consumption as less power has to be generated to heat the belt.

The present invention is particularly applicable to the steering and tensioning of an intermediate transfer or transfuse belt in a printer or copier. The intermediate transfer belt passes over a number of guide rollers. One guide roller defines a first transfer nip with a member onto which toner images have been deposited, these images being transferred to the intermediate transfer belt at this first nip. The intermediate transfer belt also passes over a heated guide roller where the temperature of the belt is raised to soften the toner image and then to a second transfer nip where the softened images are transferred to the substrate which may be in the form of a paper web or paper sheets, and fixed thereto by heat and pressure. A driven guide roller is provided at the second transfer nip. Downstream of the transfer nip, the belt also passes over a counter roller of a belt cleaning station. The steering and tensioning roller of the present invention is preferably provided between the belt cleaning station and the first transfer nip.

### BRIEF DESCRIPTION OF THE DRAWINGS

The invention will be described in further detail, purely by way of example, with reference to the accompanying drawings, in which:

FIG. 1 is a schematic illustration of a printer;

FIG. 2 is a schematic illustration of a device according to the invention for actively steering and tensioning the intermediate transfer belt of the printer shown in FIG. 1; and

FIG. 3 illustrates in more detail, the geometry of the steering and tensioning device of FIG. 2.

### DETAILED DESCRIPTION OF THE INVENTION

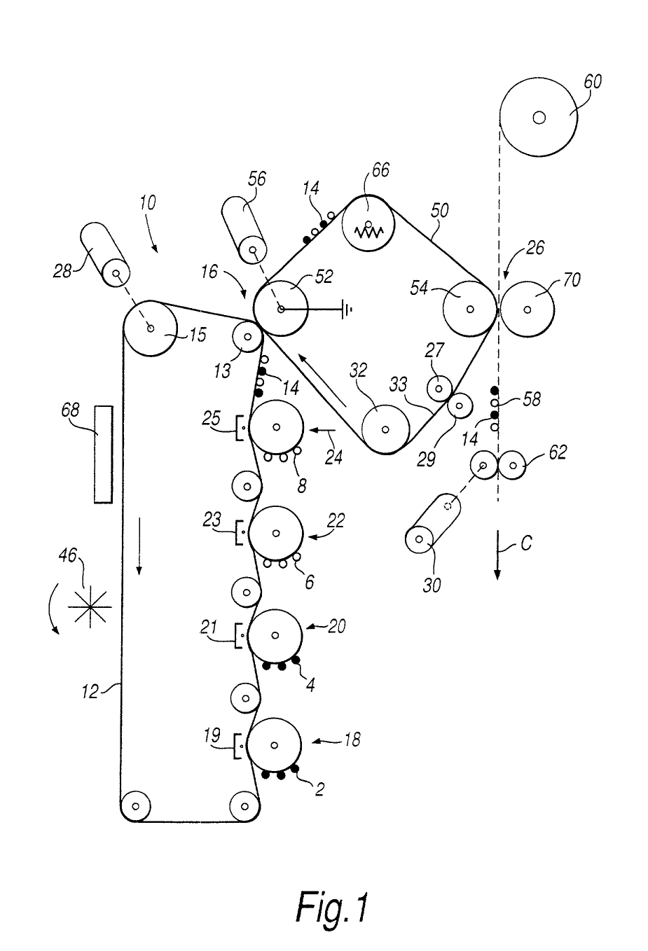

The printer 10 shown in FIG. 1 comprises a primary transfer belt 12 formed of polyethylene terephthalate (PET) having a thickness of 100 μm and having spaced along one run thereof a plurality of toner image-forming stations 18, 20, 22, 24. Each of these stations is similar to those described in U.S. Pat. No. 5,893,018 (De Bock et al./Xeikon N V), and includes a corona discharge unit 19, 21, 23, 25 to electrostatically deposit a toner image onto the PET belt 12.

The primary transfer belt 12 passes over a number of guide rollers, including a nip-forming guide roller 13 and a drive roller 15 driven by a motor 28. The primary transfer belt 12 is continuously driven in turn through the image-forming stations 18, 20, 22, 24, through an intermediate transfer nip 16, through a cooling station 68 and through a cleaning station 46.

The intermediate transfer nip 16 is formed between the guide roller 13 and an earthed guide roller 52, through which nip the primary transfer belt 12 and an intermediate transfer belt 50 pass in intimate contact with each other.

The intermediate transfer belt 50 is driven by a motor 56 continuously in turn through the intermediate transfer nip 16, over a heated roller 66 through a final transfer station 26. The heated roller 66 is positioned after the intermediate transfer nip 16 and before the second transfer station 26.

The final transfer station 26 comprises a nip formed between a guide roller 54 of the intermediate transfer belt 50 and a counter roller 70, through which nip the intermediate transfer belt 50 and a substrate in the form of a paper web 58 pass in intimate contact with each other. Drive rollers 62, driven by a motor 30, drive the web 58 in the direction of the arrow C from a supply roll 60 continuously through the final transfer station 26 where it is pressed against the intermediate transfer belt 50 by the counter roller 70.

Downstream of the final transfer station 26, the intermediate transfer belt 50 passes through a cleaning station comprising a cleaning roller 29 opposed to a counter roller 27, and thereafter over a steering and tensioning roller 32, before returning to the intermediate transfer nip 16.

The intermediate transfer nip 16 is formed between the guide roller 13 and an opposing guide roller 52 pressed towards each other to cause tangential contact between said primary transfer belt 12 and an intermediate transfer belt 50. The guide roller 13 comprises an electrically conductive core carrying a semi-insulating covering. A supply of electrical potential is provided for electrically biasing the first guide roller 13 to create an electrical field at the intermediate transfer nip 16 to assist in transferring the image 14 from the primary belt 12 to the intermediate transfer belt 50.

The intermediate transfer belt 50 is formed with an electrically conductive metal backing having a thickness of between 50 and 150 μm, such as 75 μm stainless steel or 100 μm nickel. The backing has a 100 μm surface covering formed of silicone elastomer which has a low surface energy material, relative to the surface of the primary belt 12 and of the substrate 58.

The printer is used as follows.

A plurality of developed toner images 2, 4, 6, 8 are electrostatically deposited in register with each other onto the primary transfer belt 12 at the image-forming stations 18, 20, 22, 24 to form a multiple toner image 14 on the primary transfer belt 12.

The primary transfer belt 12 carrying the multiple toner image 14 contacts the heated intermediate transfer belt 50 at the intermediate transfer nip 16 to electrostatically transfer the multiple toner image 14 to the intermediate transfer belt 50. The pressure exerted between the first guide roller 13 and the second guide roller 52 at the intermediate transfer nip 16 is about 100 N.

The intermediate transfer belt 50, with the multiple toner image carried thereon, is heated by heated roller 66 to a temperature of between 80° and 150° C., such as about 115° C., thereby to render the multiple toner image tacky.

The intermediate transfer belt 50 carrying the tacky multiple toner image 14 then contacts the web 58 at the final transfer station 26 to transfer the multiple toner image 14 thereto.

The intermediate transfer belt 50 is then brought into further contact with the primary transfer belt 12 while the intermediate transfer belt 50 is at an elevated temperature to establish a temperature gradient at said intermediate transfer nip 16. The temperature of the intermediate transfer belt 50 immediately upstream of said intermediate transfer nip 16 is greater than 50° C., such as between 100 and 115° C., that is some 70 Centigrade degrees higher than the temperature of the primary belt 12 immediately upstream of said intermediate transfer nip 16, which is between 20° and 50° C., such as about 35° C. The temperature of the intermediate transfer belt 50 falls only slightly as the belt passes through the nip, with the result that immediately upstream of the heating device 66 the temperature is about 100° C. That is the heating device 66 need only raise the temperature of the intermediate transfer belt by about 15 Centigrade degrees to bring the toner image thereon to the required temperature for final transfer.

The primary transfer belt 12 is forcibly cooled at the cooling station 68 by directing cooled air onto the primary transfer belt 12. Alternatively, instead of blowing cooled air, a cooling liquid such as water may be directed through roller 15 to cool the primary transfer belt. The primary transfer belt 12 is thereby cooled to the temperature of about 35° C. This cooling assists in establishing the required temperature gradient at the intermediate transfer nip 16.

The primary transfer belt 12 is cleaned at cleaning station 46 before the deposition of further developed toner images 2, 4, 6, 8.

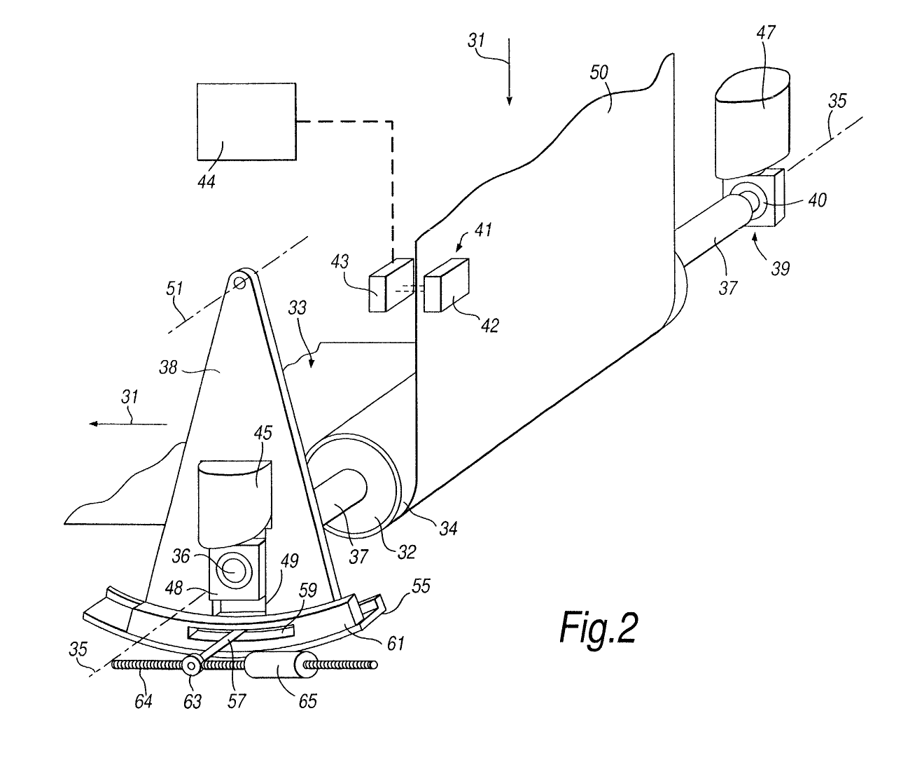

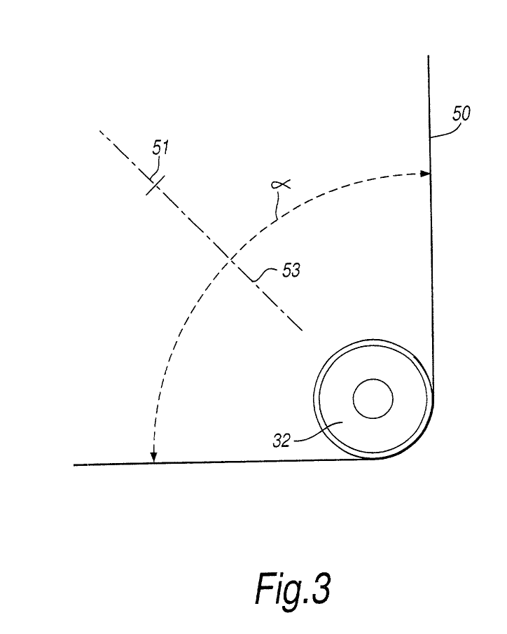

FIGS. 2 and 3 show a device according to the invention for steering and tensioning the intermediate transfer belt 50 as it moves along a predetermined path 31.

The steering and tensioning roller 32 is in the form of a freely rotatable aluminum guide roller which contacts the inner side 33 of the intermediate transfer belt 50 while the intermediate transfer belt 50 is wrapped around the guide roller 32 by a wrapping angle of about 90°. The guide roller 32 extends slightly beyond the whole web width on either side thereof. A surface layer 34 of the guide roller 32 is composed of a hard coat anodize to increase the coefficient of friction and simultaneously increase hardness and the resistance. The guide roller 32 extends along and is rotatable about an axis 35 positioned substantially transversely of the predetermined intermediate transfer belt path 31.

The guide roller 32 includes an axle 37 which extends form each end thereof. At one end 36 of the guide roller 32 the axle 37 is carried in a bearing 48, slidably mounted within a slot 49 of a support member 38. At the opposite end 39 of the guide roller 32 the axle 37 is attached to a pivotal bearing 40. The movement of the lower edge of the support member 38 is guided by a fixed guide rail 55. A pin 57 attached to the support member 38 passes through a slot 59 in an upstanding wall 61 of the guide rail 55 and a coupling 63 is provided on its free end, the coupling being in engagement with a threaded spindle 64 driven by a motor 65.

The support member 38 can be tilted about a tilt axis 51 over an angle of ±5°. By this arrangement, tilting of the guide roller 32 over a predetermined angle is possible.

The tilt axis 51 of the tiltable support member 38 lies within the wrapping angle of the web 50 around the guide roller 32. The tilting axis of the support member is substantially parallel to the axis 35 of the guide roller and lies on the bisector 53 of the wrapping angle. This arrangement means that the tilting of the support member results in substantially no variation in the speed of the web as it passes over the guide roller.

A non-contact sensor 41 is positioned to detect lateral misalignment of the intermediate transfer belt 50. The sensor comprises a light source 42 and a detector 43.

A control device 44 coupled to the sensor 41 is programmed to respond to the sensor 41 to drive a motor 65 which controls the tilting of the support member 38. In this manner, lateral misalignment of the intermediate transfer belt 50 is corrected by frictional steering of the intermediate transfer belt 50.

The output voltage of the sensor 41 is therefore indicative of the alignment of the belt is measured at the detector. The desired position of the edge of the belt 50 is centered at the detector 43, such that half of the light from the light source 42 is absorbed by the belt 50. If the belt 50 starts to drift laterally, the direction of this drift is indicated by the detected output voltage. If this detected output voltage is greater than the output voltage when the belt edge is centered (Vc), this indicates that a larger part of the detector is being exposed and that therefore the belt has drifted towards the right as viewed in FIG. 2. If on the other hand the detected output voltage is smaller than Vc, this indicates that the belt has drifted to the left.

A pair of controllable compressed air devices 45, 47 are provided for exerting a predetermined pressure in parallel directions on each end of the guide roller axle 37 independently of the position of the tiltable support member 38. The compressed air device 45 is carried on the support member 38 and acts upon the bearing 48 which carries the other end 36 of the roller 32. The compressed air device 45 applies pressure along the bisector 53 of the wrapping angle.

The other compressed air device 47 is fixed to the machine frame and acts upon the pivotal bearing 40 which carries the end 39 of the roller 32. This compressed air device 47 also applies pressure in the direction of the bisector 53.

In this manner, the compressed air devices 45, 47 act to push the guide roller 32 towards the intermediate transfer belt 50 to keep the tension of the belt at a predetermined value without speed changes.

What is claimed is:

1. A device for actively steering and tensioning a web as it moves along a predetermined path, comprising:
a rotatable guide roller for contacting an inner side of said web while said web is partially wrapped around said guide roller to define a wrapping angle, a first end of said guide roller being carried on a tiltable support member which is tiltable about a tilt axis while a second opposite end of said guide roller is attached to a pivotal bearing, thereby enabling tilting of said guide roller over a predetermined angle;
a non-contact sensor positioned to detect lateral misalignment of said web;
a control device responsive to said sensor for controlling tilting of said support member thereby to correct for lateral misalignment of said web by corrective frictional steering thereof; and
pressure devices for exerting a predetermined pressure on each end of said guide roller independently of the position of said tiltable support member, thereby, in use, to push said guide roller towards said web for tensioning thereof.

2. A device according to claim 1, wherein said pressure devices are controllable.

3. A device according to claim 1, wherein one of said pressure devices is carried on said tiltable support member.

4. A device according to claim 1, wherein each said pressure device comprises a compressed air device.

5. A device according to claim 1, wherein said tilt axis lies within said wrapping angle.

6. A device according to claim 5, wherein said predetermined pressure acts along the bisector of said wrapping angle.

7. A device according to claim 1, together with a web, wherein said guide roller extends at least over the whole width of said web.

8. A device according to claim 7, wherein said web is selected from endless belts and open ended webs.

9. A method for actively steering and tensioning a web as it moves along a predetermined path, comprising:
contacting an inner side of said web with a rotatable guide roller while said web is partially wrapped around said guide roller, a first end of said guide roller being carried on a tiltable support member while a second opposite end of said guide roller is attached to a pivotal bearing, thereby enabling tilting of said guide roller over a predetermined angle;
detecting lateral misalignment of said web by means of a non-contact sensor;
using a control device responsive to said sensor to control the tilting of said support member thereby to correct for lateral misalignment of said web by corrective frictional steering thereof; and
using pressure devices for exerting a predetermined pressure on each end of said guide roller independently of the position of said tiltable support member, thereby, in use, to push said guide roller towards said web for tensioning thereof.

10. A method according to claim 9, wherein said predetermined pressure is between 100 and 2000 N.
